(19) United States
(12) Patent Application Publication
(10) Pub. No.: US 2007/0096506 A1
(43) Pub. Date: May 3, 2007

(54) BRACKET FOR A MODULAR STRUCTURE

(76) Inventor: Brian P. Haack, Charlotte, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/538,291

(22) Filed: Oct. 3, 2006

Related U.S. Application Data
(60) Provisional application No. 60/723,535, filed on Oct. 4, 2005.

(51) Int. Cl. B60P 3/355; E04B 1/38

(52) U.S. Cl. 296/165; 296/173; 296/193.04; 52/590.3

(57) ABSTRACT

A connector assembly is provided for connecting a floor and a structural wall. The connector assembly includes a first elongated bracket mounted to one of the floor and the structural wall and defines a female channel. A second elongated bracket is mounted to the other of the floor and the structural wall and includes a male projection complimentary in configuration to the female channel. The male projection is disposed within the female channel in a dovetail type connection. At least one of the male projection and the female channel includes a plurality of longitudinally extending grooves to permit a flow of an adhesive between the male projection and the female channel along the longitudinal length of the first and second elongated brackets.

### CROSS REFERENCE TO RELATED APPLICATION

This application claims the benefit of application Ser. No. 60/723,535 filed Oct. 4, 2005, the advantages and disclosure of which are hereby incorporated by reference.

### BACKGROUND OF THE INVENTION

1. Field of the Invention

The subject invention relates to a vehicle including a slide-out structure, and more specifically to a connector assembly for connecting a floor and a structural wall of the slide-out structure.

2. Description of the Prior Art

Recreational vehicles, such as camper trailers, motor homes, etc., are sometimes provided with slide-out structures. The slide-out structure is moveable outwardly from the vehicle by a servo motor to provide additional space when the vehicle is stationary; and retractable into the recreational vehicle during transportation of the recreational vehicle.

The slide-out structure includes a floor, three walls, and a roof. Traditionally, the construction of the slide-out structure is similar to that of a traditionally framed house, in which the walls are first roughed in using dimensional lumber and then mounted to the floor. The roof is mounted over joists in a traditional fashion. Siding is affixed to the exterior of the walls and an interior wall covering is placed over the inside of the walls. Such a construction technique is very labor intensive and therefore costly.

Dovetail connections are well known for connecting two boards at right angles relative to each other. The dovetail connection includes a series of pins cut to extend from an end of one of the boards in interlocking engagement with a series of tails cut into an end of the other of the boards. The pins and the tails have a trapezoidal shape complimentary to each other for interlocking perpendicular engagement. A glue is added to the connection between the pins and the tails to bond the two boards together. Once glued, the dovetail connection provides a very strong joint connecting the two boards.

### SUMMARY OF THE INVENTION AND ADVANTAGES

The subject invention provides a vehicle comprising a body, which defines an opening. A slide-out structure is disposed within the opening and is moveable laterally relative to the body. The slide-out structure includes a floor and a structural wall extending from the floor. A first elongated bracket defines a female channel and is mounted to one of the floor and the structural wall. A male projection extends from one of the structural wall and the floor and is complimentary in configuration to the female channel. The male projection is disposed within the female channel in interlocking engagement with the female channel for connecting the floor and the structural wall. At least one of the female channel and the male projection define a plurality of grooves extending along a length of the first elongated bracket.

Accordingly, the subject invention provides a connector assembly for connecting the floor and the structural wall. The connector assembly utilizes a dovetail type connection, which quickly and easily attaches the structural wall to the floor, thereby reducing construction time of the slide-out structure while still providing a strong connection between the floor and the structural wall.

### BRIEF DESCRIPTION OF THE DRAWINGS

Other advantages of the present invention will be readily appreciated, as the same becomes better understood by reference to the following detailed description when considered in connection with the accompanying drawings wherein:

FIGS. 1 is a perspective view of a vehicle having a slide-out structure;

FIG. 2 is an exploded perspective view of a plurality of wall panels of the structural wall aligned in a straight wall segment;

FIG. 4 is side view of one of the structural wall panels;

FIG. 3 is an end view of one of the structural wall panels;

FIG. 5 is a fragmentary perspective view of a connector assembly for interconnecting a floor and a structural wall;

FIG. 6 is a fragmentary perspective view of the connector assembly;

FIG. 7 is another fragmentary perspective view of the connector assembly viewed from an opposing direction relative to FIG. 6; and

FIG. 8 is an exploded end view of the connector assembly.

### DETAILED DESCRIPTION OF THE INVENTION

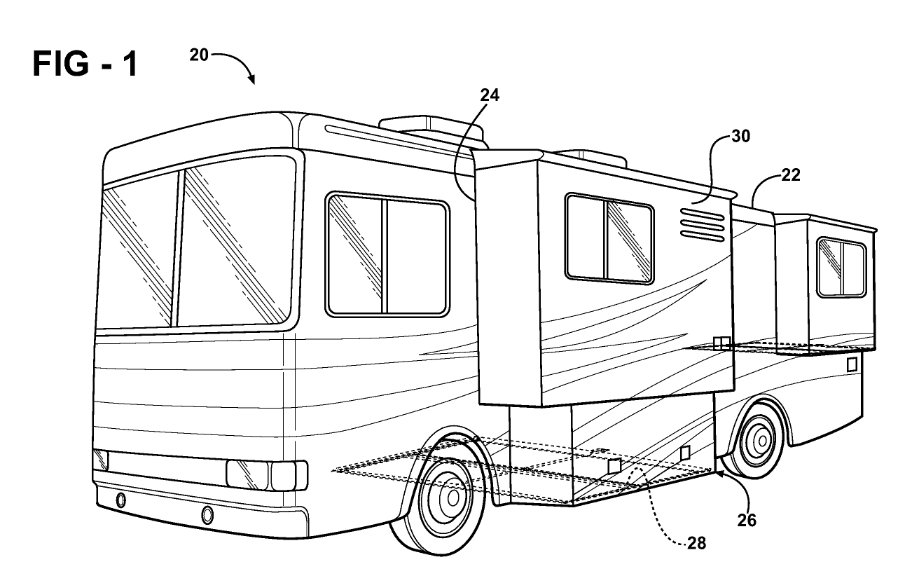

Referring to the Figures, wherein like numerals indicate corresponding parts throughout the several views, a vehicle is shown generally at 20 in FIG. 1. The vehicle 20 includes a body 22, which defines an opening 24. A slide-out structure, shown generally at 26, is disposed within the opening 24 and is moveable laterally relative to the body 22 of the vehicle 20. While the subject invention is primarily discussed herein related to the slide-out structure 26 disposed within the vehicle 20, it should be understood that the subject invention disclosed herein may also be practiced with other small structures not integrated into the vehicle 20, such as a storage shed.

The slide-out structure 26 includes a floor 28 and a structural wall 30 extending from the floor 28. The structural wall 30 may include several different wall segments arranged to form the outer periphery of the slide-out structure 26. Typically, the structural wall 30 includes three wall segments; two wall segments parallel each other with one wall segment extending therebetween, with the slide-out structure 26 being open to an interior of the vehicle 20 as is well known in the art.

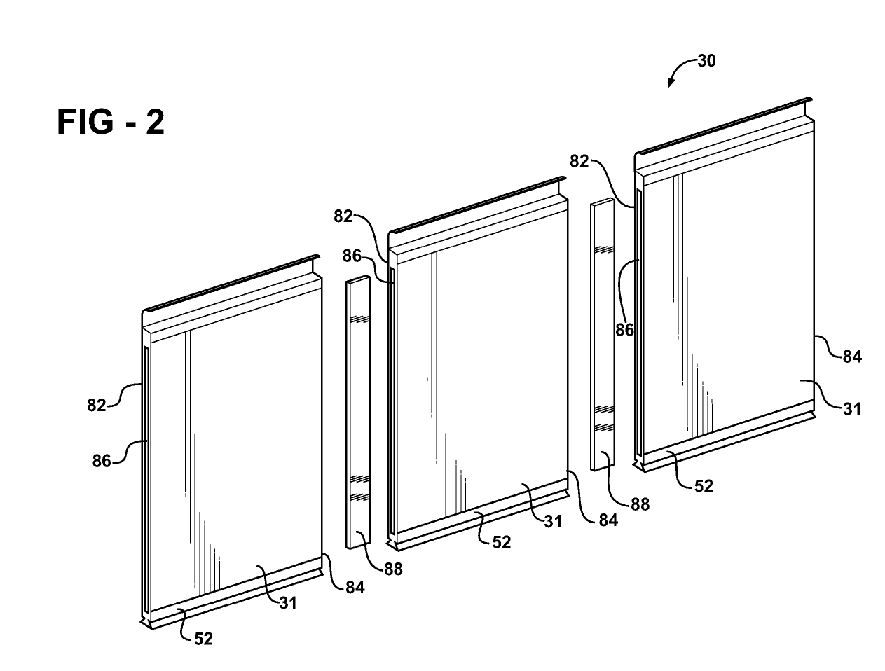

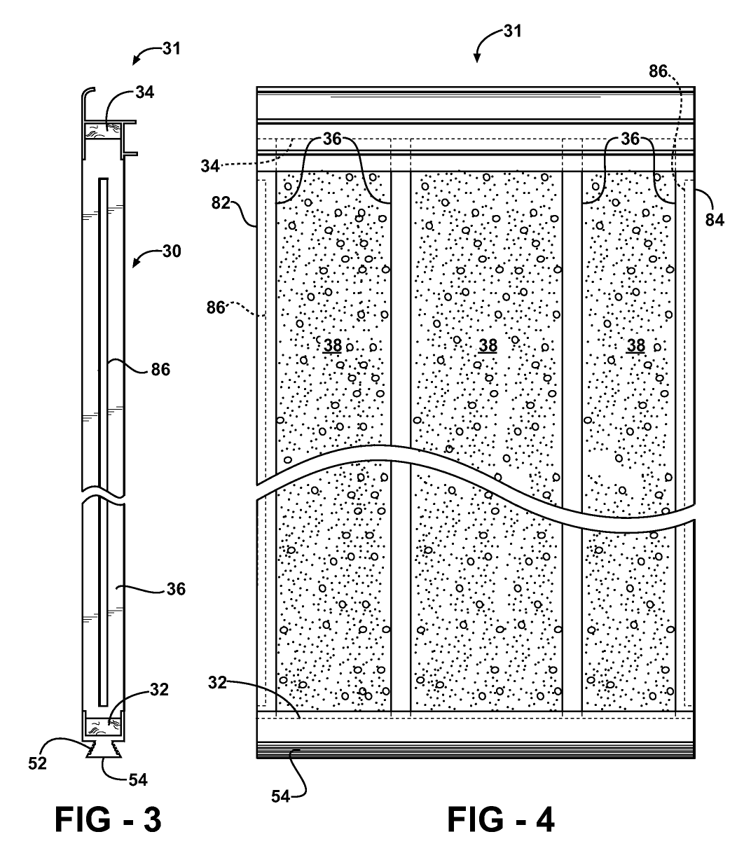

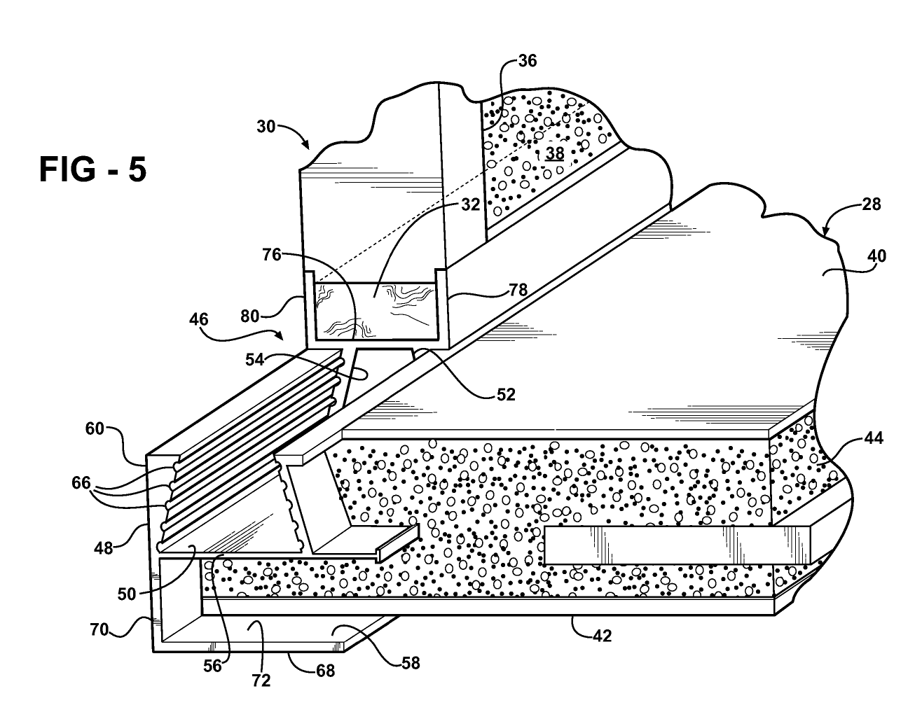

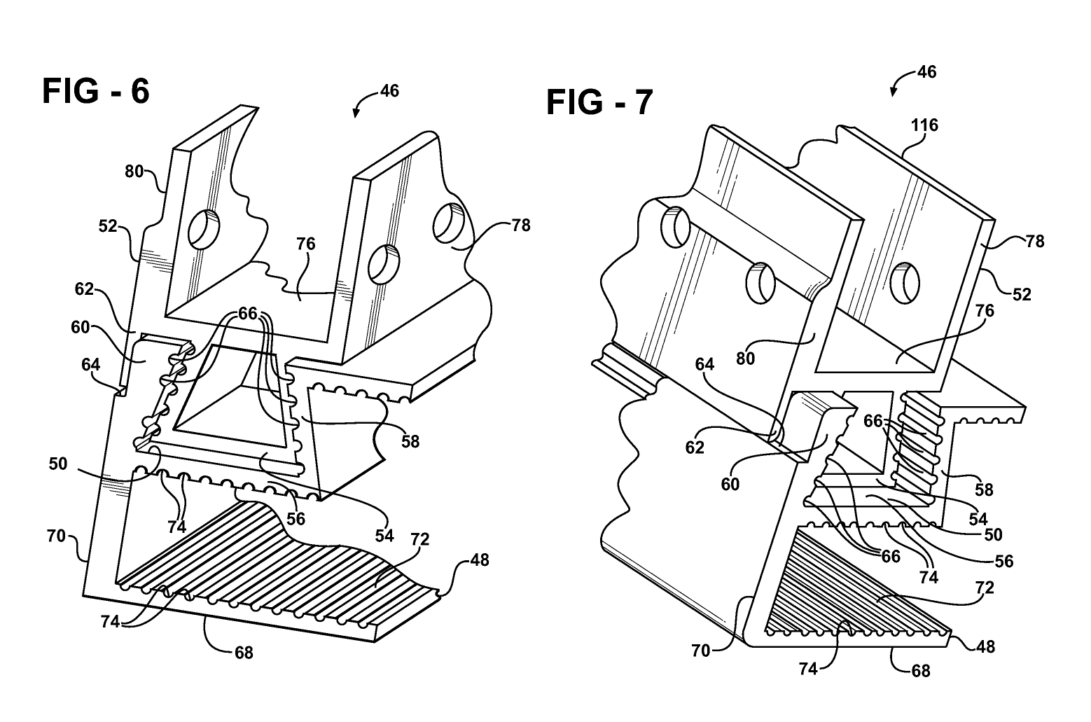

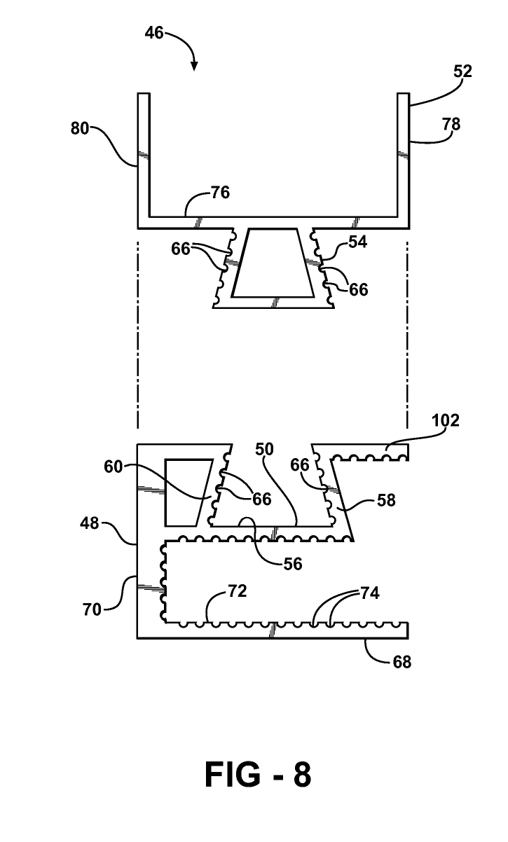

Referring to FIG. 2, each wall segment of the structural wall 30 may include a plurality of panels 31 positioned adjacent each other along a plane, i.e., forming a straight wall segment. Referring also to FIGS. 3 and 4, each of the plurality of panels 31 includes a first side edge 82 and a second side edge 84 defining a slot 86 that extends upward along a height of each of the panels 31. If the wall segment includes more than one panel 31, a spline 88 is partially disposed within each of the slots 86 of the adjacent panels 31 to interconnect the adjacent panels 31 of the structural wall 30. Accordingly, each spline 88 is partially disposed within the slot 86 of the first side edge 82 of one panel 31 and partially disposed within the slot 86 of the second side edge 84 of an adjacent panel 31, thereby connecting the panels 31 and restraining the panels 31 from lateral movement relative to each other.

Referring to FIGS. 3 and 4, each panel of the structural wall 30 includes a sill plate 32, a top plate 34, and a plurality of studs 36 extending between the sill plate 32 and the top plate 34. The structural wall 30 further includes a foam core 38 disposed about the sill plate 32, the top plate 34, and the studs 36. Preferably, the foam core 38 at least partially encapsulates the sill plate 32, the top plate 34 and the studs 36. This may be accomplished, for example, by placing the sill plate 32, the top plate 34, and the studs 36 in a mold and injecting the foam therein to encapsulate the panel, thereby forming a lightweight reinforced foam panel 31. Alternatively, the foam core 38 may comprise sheets cut to fit and placed between the sill plate 32, the top plate 34, and the studs 36.

Referring to FIG. 5, the floor 28 comprises a foam center 44. An upper support sheet 40 and a lower support sheet 42 sandwich the foam center 44 therebetween. The upper support sheet 40 and the lower support sheet 42 preferably include a fiberglass material, but may also include some other rigid material, such as an oriented strand board or a plywood, capable of providing shear and bending strength to the foam center 44 and protect the foam center 44 of the floor 28 from damage.

Referring to FIGS. 6 and 7, a connector assembly is generally shown at 46. The connector assembly 46 connects the floor 28 and the structural wall 30 and includes a first elongated bracket 48 mounted to one of the floor 28 and the structural wall 30. As shown in the Figures, the first elongated bracket 48 is mounted to the floor 28 and defines a female channel 50. A second elongated bracket 52 is mounted to the other of the floor 28 and the structural wall 30, and defines a male projection 54 complimentary in configuration to the female channel 50. An adhesive is disposed within the female channel 50 along the length of the first elongated bracket 48 and the second elongated bracket 52 for adhering the male projection 54 and the female channel 50 together. As shown in the Figures, the second elongated bracket 52 is mounted to the structural wall 30. The male projection 54 is disposed within the female channel 50 in interlocking engagement with the female channel 50, and securely connects the floor 28 and the structural wall 30 through a dovetail type connection.

The first elongated bracket 48 and the second elongated bracket 52 extend the length of the structural wall 30, i.e., each wall segment will have a corresponding length equal to the first elongated bracket 48 and the second elongated bracket 52 to interconnect each wall segment to the floor 28 along the entire length of the wall segment. As shown in the Figures and described herein, the second elongated bracket 52 is mounted to the structural wall 30. However, it should be understood that the second elongated bracket 52 may be integrally formed with the structural wall 30 as part of the sill plate 32. It should also be understood that if the second elongated bracket 52 is not integrally formed with the sill bracket 32, then either the first elongated bracket 48 or the second elongated bracket 52 may be attached to the structural wall 30, with the other of the first elongated bracket 48 and the second elongated bracket 52 being attached to the floor 28.

Referring also to FIG. 8, the first elongated bracket 48 includes a channel bottom 56, an inner channel wall 58 and an outer channel wall 60 each extending from the channel bottom 56. The channel bottom 56, the inner channel wall 58, and the outer channel wall 60 define the female channel 50 therebetween. At least one of the inner channel wall 58 and the outer channel wall 60 extends from the channel bottom 56 at an angle inclined toward the other of the inner channel wall 58 and the outer channel wall 60. Accordingly, if only one of the inner channel wall 58 and the outer channel wall 60 are inclined toward the other, than the structural wall 30 may be pivoted into a generally perpendicular relationship relative to the floor 28 from a generally horizontal relationship relative to the floor 28. As such, it is not necessary to slide the male projection 54 the length of the female channel 50 to connect the structural wall 30 to the floor 28. Preferably however, both the inner channel wall 58 and the outer channel wall 60 extend from the channel bottom 56 at an angle inclined toward the other of the inner channel wall 58 and the outer channel wall 60 respectively. As such, the male projection 54 is inserted into the female channel 50 by sliding the male projection 54 into the female channel 50 along the length of the first elongated bracket 48.

At least one of the female channel 50 and the male projection 54 define a plurality of grooves 66 extending along a length of the first elongated bracket 48 and the second elongated bracket 52. It is also contemplated that both the female channel 50 and the male projection 54 define the plurality of grooves 66. Preferably, each of the plurality of grooves 66 includes cross section having a semi-circular shape. However, it should be understood that the plurality of grooves 66 may include some other cross-sectional shape. The plurality of grooves 66 permit a sufficient quantity of an adhesive to be disposed along the entire length of the connection interconnecting the first elongated bracket 48 and the second elongated bracket 52 to adequately bond the male projection 54 to the female channel 50.

Referring back to FIGS. 6 and 7, the second elongated bracket 52 may include a finger 62 extending therefrom in overlapping engagement with one of the outer vertical wall and the inner vertical wall of the first elongated bracket 48. The finger 62 assists in providing rotational stability of the structural wall 30 relative to the floor 28 to prevent the male projection 54 from breaking or separating from the structural wall 30. The first elongated bracket 48 defines a recess 64 complimentary in shape to the finger 62 and in frictional engagement with the finger 62. More specifically, one of the inner vertical wall and the outer vertical wall of the first elongated bracket 48 define the recess 64. Accordingly, the finger 62 is flush with an inner or outer side of the first elongated bracket 48.

Referring to FIGS. 6 through 8, the first elongated bracket 48 includes a floor support wall 68 spaced from the channel bottom 56 and an end wall 70 extending between the floor support wall 68 and the channel bottom 56. The floor support wall 68, the end wall 70, and the channel bottom 56 define a floor channel 72 therebetween for supporting an outer edge of the floor 28 thereon. The floor channel 72 includes a plurality of interlocking grooves 74 extending along the length of the first elongated bracket 48. Preferably, the foam center 44 of the floor 28 is molded into the floor 28 support channel of the first elongated bracket 48 to mount the first elongated bracket 48 to the floor 28 with the foam center 44 in interlocking mechanical engagement with the interlocking grooves 74 of the floor 28 support channel. This may be accomplished, for example, by placing the first elongated bracket 48, the upper support sheet 40 and lower support sheet 42 into a mold, and injecting the foam therebetween to form the foam center 44 of the floor 28 within the floor 28 support channel of the first elongated bracket 48, the upper support sheet 40 and the lower support sheet 42. It should be understood that the interlocking grooves 74 defined by the floor 28 support channel may have any suitable cross sectional shape such as a rectangular shape, a semi-circular shape, a triangular shape, etc.

When the second elongated bracket 52 is a separate relative to the sill plate 32, as is shown in the drawings, the second elongated bracket 52 includes a bottom member 76, an inner vertical member 78 and an outer vertical member 80. The inner vertical member 78 and the outer vertical member 80 extend from the bottom member 76, and define a U-shaped channel between the bottom member 76, the inner vertical member 78, and the outer vertical member 80. The U-shaped channel receives the sill plate 32 and a portion of the studs 36 therein so that the inner vertical member 78 and the outer vertical member 80 may be attached to the studs 36 to secure the second elongated bracket 52 to the studs 36.

The first elongated bracket 48 and the second elongated bracket 52 comprise a rigid material such as a hard plastic material, or a metal material. Preferably, the first elongated bracket 48 and the second elongated bracket 52 are formed from an extruded aluminum. However, it should be appreciated that the first elongated bracket 48 and the second elongated bracket 52 may be formed from the hard plastic material or from some other metal material, such as steel.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A vehicle comprising:
a body defining an opening;
a slide-out structure disposed within said opening and moveable laterally relative to said body with said slide-out structure including a floor and a structural wall extending from said floor;
a first elongated bracket defining a female channel with said first elongated bracket mounted to one of said floor and said structural wall;
a male projection extending from one of said structural wall and said floor with said male projection being complimentary in configuration to said female channel and disposed within said female channel in interlocking engagement with said female channel for connecting said floor and said structural wall;
at least one of said female channel and said male projection defining a plurality of grooves extending along a length of said first elongated bracket.

2. A vehicle as set forth in claim 1 wherein each of said plurality of grooves include a cross section having a semi-circular shape.

3. A vehicle as set forth in claim 1 wherein said first elongated bracket includes a channel bottom, an inner channel wall and an outer channel wall each extending from said channel bottom with said channel bottom and said inner channel wall and said outer channel wall defining said female channel therebetween wherein one of said inner channel wall and said outer channel wall extends from said channel bottom at an angle inclined toward the other of said inner channel wall and said outer channel wall.

4. A vehicle as set forth in claim 3 wherein each of said inner channel wall and said outer channel wall extend from said channel bottom at an angle inclined toward the other of said inner channel wall and said outer channel wall respectively.

5. A vehicle as set forth in claim 3 wherein said first elongated bracket includes a floor support wall spaced from said channel bottom and an end wall extending between said floor support wall and said channel bottom with said floor support wall and said end wall and said channel bottom defining a floor channel therebetween for supporting said floor thereon.

6. A vehicle as set forth in claim 5 wherein said floor channel includes a plurality of grooves extending along said length of said first elongated bracket.

7. A vehicle as set forth in claim 1 wherein said first elongated bracket comprises a plastic.

8. A vehicle as set forth in claim 1 wherein said first elongated bracket comprises a metal.

9. A vehicle as set forth in claim 1 further comprising an adhesive disposed within said female channel along said length of said first elongated bracket for adhering said male projection and said female channel together.

10. A vehicle as set forth in claim 3 further comprising a second elongated bracket mounted to one of said structural wall and said floor and defining said male projection for engagement with said female channel defined by said first elongated bracket.

11. A vehicle as set forth in claim 10 wherein said second elongated bracket comprises a plastic.

12. A vehicle as set forth in claim 10 wherein said second elongated bracket comprises a metal.

13. A vehicle as set forth in claim 10 wherein said second elongated bracket includes a finger extending from said second elongated bracket in overlapping engagement with one of said outer vertical wall and said inner vertical wall of said first elongated bracket.

14. A vehicle as set forth in claim 13 wherein said first elongated bracket defines a recess complimentary in shape to said finger and in frictional engagement with said finger.

15. A vehicle as set forth in claim 14 wherein one of said inner vertical wall and said outer vertical wall define said recess.

16. A connector assembly for connecting a floor and a structural wall, said assembly comprising:
a first elongated bracket defining a female channel for attachment to one of the floor and the structural wall;
a second elongated bracket defining a male projection complimentary in configuration to said female channel and disposed within said female channel in interlocking engagement with said female channel for attachment to one of the floor and the structural wall to connect the floor and the structural wall;
at least one of said female channel and said male projection defining a plurality of grooves extending along a longitudinal length of said female channel and said male projection for permitting a flow of an adhesive between said female channel and said male projection while said male projection is disposed within said female channel.

17. A vehicle as set forth in claim 16 wherein each of said plurality of grooves include cross section having a semi-circular shape.

18. A vehicle as set forth in claim 16 wherein said first elongated bracket includes a channel bottom, an inner channel wall and an outer channel wall each extending from said channel bottom with said channel bottom and said inner channel wall and said outer channel wall defining said female channel therebetween wherein one of said inner channel wall and said outer channel wall extends from said channel bottom at an angle inclined toward the other of said inner channel wall and said outer channel wall.

19. A vehicle as set forth in claim 18 wherein each of said inner channel wall and said outer channel wall extend from said channel bottom at an angle inclined toward the other of said inner channel wall and said outer channel wall respectively.

20. A vehicle as set forth in claim 18 wherein said first elongated bracket includes a floor support wall spaced from said channel bottom and an end wall extending between said floor support wall and said channel bottom with said floor support wall and said end wall and said channel bottom defining a floor channel therebetween for supporting said floor thereon.

21. A vehicle as set forth in claim 20 wherein said floor channel includes a plurality of grooves extending along said length of said first elongated bracket.

22. A vehicle as set forth in claim 18 wherein said second elongated bracket includes a finger extending therefrom in overlapping engagement with one of said outer vertical wall and said inner vertical wall of said first elongated bracket.

23. A vehicle as set forth in claim 22 wherein said first elongated bracket defines a recess complimentary in shape to said finger and in frictional engagement with said finger.

24. A vehicle as set forth in claim 23 wherein one of said inner vertical wall and said outer vertical wall define said recess.

25. A vehicle as set forth in claim 16 wherein said first elongated bracket comprises a plastic.

26. A vehicle as set forth in claim 16 wherein said first elongated bracket comprises a metal.

27. A vehicle as set forth in claim 16 wherein said second elongated bracket comprises a plastic.

28. A vehicle as set forth in claim 16 wherein said second elongated bracket comprises a metal.
